(19) United States
(12) Patent Application Publication
(10) Pub. No.: US 2004/0126478 A1
(43) Pub. Date: Jul. 1, 2004

(54) Method of preparing freeze dried bean paste

(75) Inventor: Michimasa Kumagai, Yokohama-shi (JP)

Correspondence Address: Cooper & Dunham LLP., 1185 Avenue of the Americas, New York, NY, 10036, US

(73) Assignee: Nagatanien Co., LTD.

(21) Appl. No.: 10/734,036

(22) Filed: Dec. 11, 2003

(30) Foreign Application Priority Data
Dec. 25, 2002 (JP) 2002-374979

(51) Int. Cl. A23C 1/06

(52) U.S. Cl. 426/629; 426/384

(57) ABSTRACT

Water-thinned bean paste is chilled and non-fluidized, and the solidified bean paste is loaded into an air-permeable container, where the non-fluidized bean paste is freeze-dried and thus the water content is sublimed or evaporated from the entire surface of the bean paste. With the freeze-dried bean paste manufacturing method, a freeze-dried bean paste can be manufacture without requiring special facilities or an additive, at a low drying cost, and thus manufactured paste has an excellent flavor and taste and a high solubility to hot water even in a coarse block shape after being dried.

### CROSS-REFERENCE TO RELATED APPLICATIONS

This application is based upon and claims the benefit of priority from the prior Japanese Patent Application No. 2002-374979, filed Dec. 25, 2002, the entire contents of which are incorporated herein by reference.

### BACKGROUND OF THE INVENTION

1. Field of the Invention

The present invention relates a method of preparing a freeze dried bean paste (miso in Japanese) that has an excellent solubility and has an original flavor of fresh bean paste. More specifically, the present invention relates to a method of preparing a freeze dried bean paste that can be formed into various types such as powder, flake and block.

2. Description of the Related Art

Precooked bean paste soup that uses freeze dried bean paste is now very popular, and there are various types of forms of freeze dried bean paste, such as powder, granule and block. The general method of preparing these types of freeze dried bean paste takes the following steps. That is, fresh bean paste is put on a metal-made tray to spread all over it, and then it is freeze-dried. Thus obtained freeze dried bean paste is hardly consolidated. This freeze dried bean paste, as it is, cannot reconstruct a miso (bean paste) soup if hot water is applied thereto. Therefore, the consolidated paste is crushed into powder, and thus obtained powder is used as freeze dried bean paste.

However, even thus obtained powdered bean paste still does not dissolve well in hot water since it is made of hard, solid and low-soluble grains. Further, such powdered bean paste has a mouth feel of insufficiently dissolved powder. Further, since the powder is made by crushing hard dried bean paste, the bean paste is adversely affected by the heat generated in the crushing (thermal hysteresis), deteriorating the flavor of the bean paste as compared to that of the original fresh bean paste. The problem of the low solubility of the freeze-dried bean paste is caused by the following defect. That is, when freeze-drying bean paste, it is dried without being completely frozen, and the bean paste is vacuum-dried in reality.

More specifically, as the drying of the bean paste proceeds, the water content of the paste migrates to the surface of the paste, which serves as an evaporating surface. Along with the water content, other dissolved components migrate to the upper surface. If the water content is evaporated, then the regional condensation of the dissolved components occurs on the surface, causing the hardening of the surface. Thus, a hard and solid dried material is created.

As a solution for such a problem, various methods have been proposed. Known examples of these methods are a technique (disclosed in Jpn. Pat. Appln. KOKAI Publication No. 57-43230), in which 20 to 200 parts by weight of water is added to, in ratio, 100 parts by weight of bean paste and homogenized, followed by preliminary freezing, and then the resultant is freeze-vacuum dried, and a technique (disclosed in Jpn. Pat. Appln. KOKAI Publication No. 59-175860), in which a mixture containing fresh bean paste, a gummy agent and water (a moisture content of which is 62 to 80% by weight) is homogenized, and then the resultant is freeze-dried.

Further, also known in a method in which the moisture content of bean paste is adjusted to 65 to 75% by weight and a predetermined amount of gummy viscosity-increasing polysaccharide is contained therein, followed by freeze-drying. With this method, not only the reconstructing property but also the drying efficiency are improved, and the deformation does not easily take place when drying. Thus, it is possible to obtain dry solid bean paste without a brittleness. (See Jpn. Pat. Appln. KOKAI Publication No. 8-103240.) Further, also known is a technique in which half dried bean paste is extruded to a vacuum space to increase its size of grains and then dried while granulating it. With this technique, the handleability, the taste and flavor, and the solubility of the bean paste can be improved. (See Jpn. Pat. Appln. KOKAI Publication No. 56-46388.) Furthermore, there has been proposed a method in which bean paste is granulated and dried while stirring it at a high speed under vacuum using an airtight mixer equipped with a chopper such as a stirring impeller. (See Jpn. Pat. Appln. KOKAI Publication No. 7-155128.)

However, with the method of adding water to bean paste, disclosed in Jpn. Pat. Appln. KOKOKU Publication No. 57-43230, the addition of 20 to 200 parts by weight of water makes about 51 to 82% by weight of moisture content. According to a preferable numerical value of this patent, 50 to 100 parts by weight of water is added, which makes about 63 to 73% by weight of moisture content. As compared to ordinary bean paste, which has a moisture content of about 45% by weight (see Food Composition Table of 5th Amended Version), the bean paste of this prior art document contains a high moisture content, which requires a high drying cost. Further, according to the same calculation, the moisture content of the water-added bean paste discussed in Examples 1 and 2 of this document is about 67% by weight.

In the Examples of Jpn. Pat. Appln. KOKAI Publication No. 59-175860 and Jpn. Pat. Appln. KOKAI Publication No. 8-103240, the moisture content of the bean paste before being dried is adjusted to 69% by weight. Conversion of this content into the amount of water added to bean paste reveals that a great amount of water, specifically 70% by weight of more of the weight of the bean paste, is added in both cases. Therefore, these cases are also disadvantageous in terms of drying cost.

Further, regarding the quality, dried products obtained after adding a lot of water each have a poor shock resistance, and therefore, the products should be, if they are in a block state, protected with a container such as a tray. Further, these products are not suitable to be coarsely crushed into flakes or appropriately sized into grains. If such a bean paste that 70% by weight or less of water was added thereto in weight ratio to that of the bean paste (that is, the moisture content of 68% by weight or less), is dried, cavities are created inside the dried product and the surroundings of the cavities are hardened and browned, thereby causing a poor solubility. Thus, if the amount of water added is simply decreased, the original object cannot be achieved.

In Jpn. Pat. Appln. KOKAI Publication No. 8-103240, a gummy agent or the like is added to improve the drying efficiency, thereby achieving prevention of foaming and swelling, or prevention of deformation. However, the addition of such a viscosity-increasing agent deteriorates the flavor and taste of the bean paste, which are most important for the food, thereby lowering the value of the food. Further, in Jpn. Pat. Appln. KOKOKU Publication No. 56-46388 and Jpn. Pat. Appln. KOKAI Publication No. 7-155128, not only the process of drying and granulating the bean paste is complicated and it requires special facilities, but also it cannot be applied to any other form but granular, which is not desirable.

As described, in the freeze dry technique for bean paste, which is designed to improve the reconstructing property of the original flavor and taste, a great amount of water is added as a general procedure. This is because with the ordinary freeze dry technique, the material temperature of the bean paste does not reach the eutectic crystal point as it is, and the bean paste is not completely freeze-dried. In order to solve this problem, water is added to increase the ice crystal portion in the bean paste, thereby relatively decreasing the liquid phase portion. Thus, the bean paste is made porous in order to increase its drying efficiency.

Therefore, thus obtained dried product has a porosity proportional to the amount of water added. In this case, the solubility of the bean paste can be increased, but in reverse, the flavor of the original bean paste is lost and further the drying cost is high. Moreover, thus obtained dried bean paste has, as a material, a weak property and therefore it is difficult to coarsely crush it into shapes such as flakes.

Thus, an object of the present invention is to obtain a freeze dry bean paste that can be prepared without requiring special facilities or an additive, at a low drying cost, and has an excellent flavor and taste and a high solubility to hot water even in a coarse block shape after being dried. Another object of the invention is to provide a freeze dry bean paste having a material property of such a strength that is appropriate to be crushable into flakes or grains.

### BRIEF SUMMARY OF THE INVENTION

According to the present invention, first, water is added to bean paste and they are mixed into thinned bean paste. Then, thus thinned bean paste is put into a container to be chilled and made non-fluid, and the solidified bean paste is transferred and loaded into another air-permeable container. Subsequently, the non-fluid bean paste loaded in the air-permeable container is freeze-dried and thus the water content is sublimed or evaporated from the entire surface of the bean paste. In this manner, the present invention prepares a freeze dry bean paste that can be prepared without requiring special facilities or an additive, at a low drying cost, and has an excellent flavor and taste and a high solubility to hot water even in a coarse block shape after being dried.

Additional objects and advantages of the invention will be set forth in the description which follows, and in part will be obvious from the description, or may be leaned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The file of this patent contains at least one photograph executed in color. Copies of this patent with color photographs will be provided by the Patent and Trademark Office upon request and payment of the necessary fee.

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram showing a cross section of a freeze-dried bean paste obtained by a preparation method according to an embodiment of the present invention; and

FIG. 2 is a diagram showing a cross section of a freeze-dried bean paste obtained by a conventional preparation method.

### DETAILED DESCRIPTION OF THE INVENTION

In the present invention, first, water is added to bean paste to prepare a thinned bean paste, and the thinned paste is chilled and made non-fluid. Then, the solidified bean paste is transferred and loaded into an air-permeable container, and freeze-dried. Thus, the water content is sublimated or evaporated from the entire surface of the bean paste. Here, while freeze-drying the bean paste, the liquid phase is migrated and dispersed in all directions, and thus the surface hardening is reduced. Further, in this invention, the water content of the bean paste is sublimated or evaporated from the entire surface of the paste. Therefore, the water content sublimation amount is large in an initial stage, and the liquid phase, which includes unfrozen water and dissolved components of bean paste, is highly concentrated quickly. Further, the liquid phase of the bean paste has viscosity and therefore the migration of the liquid phase does not easily occur, thereby making it possible to prevent the flavor and taste from being lost.

In the present invention, water is first added to bean paste, and they then thus thinned paste is chilled and made non-fluid, and the water content of the non-fluid bean paste is sublimated or evaporated from the entire surface of the paste. The water content of the paste is sublimated or evaporated by way of the followings. That is, the chilled and non-fluid bean paste is loaded into an air-permeable container, and freeze-dried in this state.

In the conventional method of drying bean paste, the water content is sublimated and evaporated from only the side of the bean paste placed in the container, which is not brought into contact with the container, that is, the upper surface of the bean paste. Therefore, as the drying progresses, the liquid phase, which consists of unfrozen water and dissolved components of bean paste, migrates towards the upper surface of the bean paste, and the phase is dried, made non-fluid and hardened there to make a block layer, which serves to impede the drying of the inside of the paste. The inventors of the present invention focused on this fact.

Based on the above-described fact, the inventors came to the conclusion that in the freeze-drying of bean paste, the sublimation and evaporation are allowed to occur through the entire surface of the bean paste, thus the migration and dispersion of the liquid phase take place in all directions, thereby reducing the surface hardening. Further, when the sublimation progresses from the entire surface of the bean paste, a great amount of water content is sublimated in an initial stage, and the liquid phase consisting of unfrozen water and dissolved components of the bean paste is highly concentrated quickly. For this reason, the inventors considered that the liquid phase, which has a viscous property, would not migrate while the water content portion is being dried, but it could be dried and made non-fluid there. The inventors carried out a number of experiments based on the above-described estimations, and have achieved the present invention.

Further, the inventors studied the amount of water added in order to increase the sublimation amount at the initial stage of the freeze-drying of bean paste, and confirmed by experiments that even if the amount of water added is decreased as compared to that of the conventional method, the above-described advantageous effect could be obtained.

Moreover, as the thickness of the layer of the bean paste to be dried becomes larger, it is more difficult to allow the sublimation and evaporation from the inside of the paste. Therefore, in order to promote the escaping of the water content, holes may be made or lines may be carved in the bean paste. They found that, in this manner, a freeze-dried bean paste having an excellent solubility could be obtained.

The thus obtained freeze-dried bean paste naturally has an excellent solubility. Further, the porous and weak properties of the paste have been improved, and it has a dense internal structure with uniform pores. With this structure, the freeze-dried bean paste has such strength that it can be easily crashed coarsely and then regularly granulated. The present invention will now be described in further detail.

The term “bean paste” (miso in Japanese) of the present invention covers various kinds including miso made with use of malted rice (kome miso), miso with use of malt (mugi miso), miso made with use of malted bean (mame miso), seasoned miso to which seasonings and flavors have been added, and further miso with ingredients such as scallion, seaweeds, bean curd (tofu) and pieces of deep-fried tofu. In the present invention, water is mixed into the bean paste in order to make the water content uniform. In this manner, the ice crystal portion is made larger in relative to the liquid phase portion, which can improve the restorability of the bean paste when hot water is added thereto, and at the same time, can enhance the drying efficiency. A preferable amount of water added is that to make the moisture content of the bean paste of 56 to 70% by weight, which is, when converted into the amount of water added, 25 to 80% by weight with respect to the weight of the bean paste. A more preferable moisture content of the bean paste is 58 to 67% by weight, which is, when converted into the amount of water added, 30 to 60% by weight with respect to the weight of the bean paste.

With the above-mentioned moisture content, it is possible to convert the bean paste to have such a tolerance and strength that is required to make a dried bean paste coarsely crushable into a block or flake shape. In the case where no particular shape is desired, for example, where the paste is to be powdered, it suffices only if the moisture content is 56% by weight. There is no particular upper limit in the moisture content, but it is usually set to 80% by weight in consideration of the drying cost. The mixing to be carried out after the addition of water is performed by appropriately using an ordinary mixing stirrer or kneader, and here the puffing effect is not particularly required.

Next, the thinned bean paste obtained by mixing bean paste with water is placed to have a thickness of, for example, 30 mm on an ordinary plastic container, and then it is chilled and made non-fluid. The chilling and non-fluidization is carried out by let the material stand in a freezer of, for example, −25° C. for 7 hours. With the chilling carried out here, the thinned bean paste that had some fluidity increases its viscosity and reduces its fluidity, and it eventually loses fluidity to become a lump. Next, the solidified bean paste is transferred to an air-permeable container, where the water content thereof is made sublimated or evaporated from substantially the entire surface of the non-fluid bean paste after the addition of water. The expression “substantially the entire surface” used here is meant to be that not only the upper and side surfaces of the bean paste, but also the part of the bottom surface thereof is communicated to the outside or in an air-permeable state. When transferring the bean paste to the air-permeable container, appropriate conditions including the thickness of the layer of the bean paste that fills the container should be selected in accordance with the size of the area of the communicating section of the container to the outside.

The air-permeable container used here is a container having air holes in all the surfaces or a container made of an air-permeable material. Examples of the former container provided with air holes in all the surfaces are containers made of a metal-made or plastic-made mesh, and perforated tray containers formed by punching pores in a metal material or the like. A more preferable example is a tray-shaped container provided with a wire netting or punched plate inside with a slight gap between it and the bottom of the tray. With use of the container, cracked pieces and the like of the chilled and non-fluid bean paste drop through the net or punched holes onto the tray underneath. Therefore, these pieces can be collected and later discarded, which is preferable in terms of operability. Usually, it suffices of these containers have a porosity (pore ratio) of 30% or more with respect to the entire area of the bottom surface of the bean paste.

However, when the containers provided with a wire netting or punched plate placed on the bottom, or the containers having air holes, such as perforated-plate containers are used, the water-thinned bean paste flows out from the air holes. Therefore, such paste with a high fluidity cannot be directly put on the containers provided with a wire netting or punched plate placed on the bottom, or the perforated-plate containers. For this reason, it is necessary that the water-thinned bean paste should placed in another container to be chilled and made non-fluid in advance, and thus non-fluid paste should be transferred to the air-permeable container to be freeze-dried.

Further, if the bottom portion of the containers provided with a wire netting or punched plate placed on the bottom, or of the perforated-plate containers, is made to have an irregular shape such as wavy, the contact area between the non-fluid bean paste placed there and the bottom surface of the container can be reduced. Further, with this structure, there is a gap created between the bottom portion of the bean paste and the bottom of the container, thus securing more communication between the bottom of the bean paste and the outside.

Alternatively, it is also possible that the relationship between the bottom portion of the container and the bottom portion of the bean paste is reversed. More specifically, bean paste is chilled and made non-fluid in a container having an irregular bottom portion, to form an irregular surface on the bottom portion of the bean paste, and then, thus obtained non-fluid bean paste is loaded with the irregular surface thereof facing downwards, in the air-permeable container having a plate-like bottom surface.

When the process is carried out industrially, the thickness of the layer of a chilled and non-fluid bean paste to be loaded in the air-permeable container is 20 to 30 mm. When a relatively thin layer of about 10 mm or less is to be dried, the initial object can be achieved by freeze-drying the paste as it is. However, when the thickness of the layer of the bean paste exceeds about 10 mm, the paste swells and deforms to create a hard dry layer inside in some cases. In order to avoid this, it is preferable that holes should be made in the paste and/or lines should be carved on its surface, to create a communication between the inside of the bean paste and the outside. These holes are made in the following manner. That is, the bean paste is chilled and made non-fluid, a steel wire or the like is pieced through or halfway through the bean paste from its surface, thus communicating the inside of the paste to the outside. The size of the holes should preferably be, for example, 1 mm in diameter, and the interval between adjacent holes should preferably be about 25 mm in pitch. On the other hand, the lines are carved in the following manner. With a sharp edged tool such as knife, uniform cuts are made in the chilled and non-fluid bean paste. It is necessary that thus formed holes and cuts of the chilled and non-fluid bean paste should be maintained until it is freeze-dried so as not to disturb the communication between the inside of the paste and the outside due to melting or the like, which may take place afterwards.

The latter containers that are made of an air-permeable material can inhibit water-thinned bean paste from leaking directly to the outside from the bottom surface of the container even if the water-thinned bean paste has a high flowability. Examples of these containers are those made of a Styrofoam material having an air-permeability, those made of paper or cloth and those prepared by laying paper or cloth in containers made of a wire netting or the like. In short, the container may be of any type as long as it can inhibit water-thinned flowable bean paste loaded in the container, from leaking directly to the outside from the bottom surface thereof, but it allows the water content of the paste to sublimate or evaporate from the bottom portion of the paste. With use of these containers, it is possible that the water-thinned bean paste is loaded directly in the air-permeable container, where the paste is chilled and made non-fluid, followed directly by freeze-drying.

The bean paste loaded in the air-permeable container is then subjected to freeze-drying by an ordinary method. In the case of a container of the type that has air holes made in the bottom portion thereof, such as a wire netting container, it is necessary to provide, before setting the air-permeable container in a drier for freeze-drying, a slit in the bottom of the container. This is because when the bottom of the container is placed in contact with the heating shelf, the air permeability of the container is lost. On the other hand, in the case of the Styrofoam container having air-permeability in its entire body, the water content is evaporated through the material of the container and therefore such a slit discussed above is not particularly required.

The thus obtained freeze-dried bean paste has such a strength that it can be formed into a block-shaped final product. Further, thus obtained bean paste has dense and very fine voids unlike the conventional dried product of bean paste thinned with a great amount of water, which is an excessive porous state. Therefore, the freeze-dried product of the present invention can maintain the flavor and taste of the original bean paste. Further, the oxidization, which might occur when storing the product, can be suppressed.

Moreover, as a characteristic of the dried bean paste obtained by the present invention, the freeze-dried bean paste can be coarsely crushed into flakes or regulated into granules. Therefore, the bean paste of the present invention can be arbitrarily shaped into various grain sizes in accordance with a target product form. This process can be done by, for example, a flake crusher equipped with a screen, which serves as crushing and granular regulating device. Further, the powdered form of the bean paste can be obtained easily by crushing dried bean paste with an appropriate crusher. This process generates a very little heat when crushing the dried paste, and therefore it is possible not only to maintain the flavor and taste of the original flavor but also to improve the powdery mouth feel and taste that is innate to the conventional powdered bean paste. Furthermore, the amount of water added to bean paste can be reduced, thereby making it possible to reduce the cost required by drying.

### EXAMPLES

### Example 1

Water was added to a red color-based kome miso (bean paste made with use of malted rice) having a water content of 46.0% by weight and the water-thinned miso was mixed uniformly with a domestic rubber-made spatula. Thus, seven types of water-thinned bean pastes having water contents of 55% by weight to 70% by weight increasing in steps were prepared. Each respective bean paste was loaded in a plastic container having dimensions of 280×200×50 (mm), to have a depth of 30 mm, and each container was let stand in a freezer of −25° C. for 7 hours to non-fluidize the paste.

Next, each chilled and non-fluid paste was transferred to a respective stainless perforated tray (of 340×235×35 (mm)) with perforations each having a diameter of 2 mm, punched uniformly in the entire surface at an interval of 3 mm (porosity of 40%). After that, holes were made in each paste with a metal rod having a diameter of 0.8 mm, which was pieced to make each hole from the upper surface of the paste substantially through to the bottom portion thereof uniformly in the entire paste at an interval of 2 cm. After that, each tray was placed in a freeze-drier with an interval of 5 mm maintained between the tray and the shelf, and freeze-dried at a vacuum degree of 0.3 Torr and a shelf temperature of 60° C. to 40° C.

For comparison, a bean paste having a water content of 64% by weight was placed in a stainless container with no hole punched, and it was freeze-dried under the same conditions as those described above, except for the type of the container. The water contents of the bean pastes and the characteristics of the respective freeze-dried bean pastes are shown in TABLE 1.

It should be noted that the evaluation of each characteristic was made in the manners described below TABLE 1. The solubility to hot water is a value obtained when a block state having a dimension of about 3 cm was dissolved with hot water. The coarse crush suitability indicates when the respective dried paste was crushed into a grain size of 4 to 10 mesh with use of a flake crusher having a screen of φ8 mm.

TABLE 1

| | Water | Amount of | | | |
|---|---|---|---|---|---|
| | contents | water added | | Solubility to | Coarse crush |
| No. | (%) | to miso (%) | Dryness | hot water | suitability |
| 1 | 55.0 | 20 | Δ | Δ | ▴ |
| 2 | 58.5 | 30 | ◯ | ◯ | ◯ |
| 3 | 61.4 | 40 | ◯ | ◯ | ◯ |
| 4 | 64.0 | 50 | ◯ | ⊚ | ◯ |
| 5 | 66.2 | 60 | ◯ | ⊚ | ◯ |
| 6 | 68.2 | 70 | ◯ | ⊚ | Δ |
| 7 | 70.0 | 80 | ◯ | ⊚ | Δ |
| Control | 64.0 | 50 | X | X | X |

Dryness ◯: good; Δ: fair but surface somewhat hardened, swollen, browned; X: having cavity inside and brown hardened layer is present.
Solubility to hot water ⊚: excellent; ◯: good; Δ: fair but somewhat insoluble; X: taking time to dissolve
Coarse crush suitability ◯: good; Δ: fair but somewhat powdery; ▴: fair but a little hard powder is present; X: hard powder present and generates heat when crushed

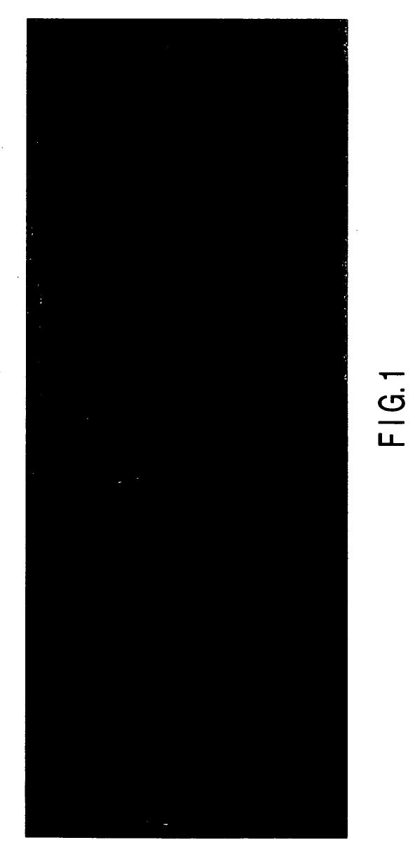

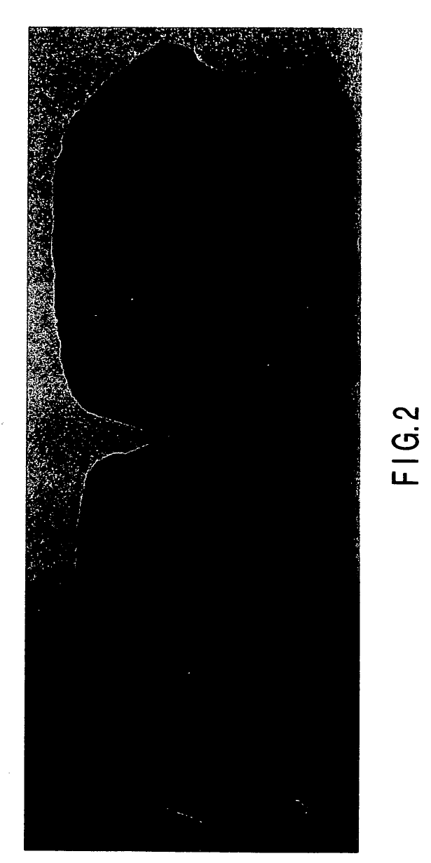

From the results summarized in TABLE 1, it can be understood that when the water content of the bean paste was set to 55 to 70%, and the bottom portion of the paste was communicated to outside, such bean pastes that could be easily dissolved into hot water if lightly stirred and could be coarsely crushed into a certain grain size were obtained. Of these pastes, those having water contents of 58 to 67% generated less fine grains and had a high coarse crush suitability, and the grains of those pastes were dissolved as soon as they were added to hot water without stirring. Further, the products of the present invention sufficiently maintained the flavor of the original bean paste and had excellent taste as well. It should be noted here that FIG. 1 shows a photograph of a section of the freeze-dried bean paste No. 2 when it is cut in half, and FIG. 2 shows a photograph of a section of the reference freeze-dried bean paste indicated in TABLE 1 when it is cut in half.

### Example 2

To 1700 g of a light color-based kome miso (bean paste made with use of malted rice) having a water content of 46.6% by weight, 680 g of water (40% by weight to that of the bean paste) and 124 g of seasonings (48 g of sodium glutamate, 60 g of powdered dried bonito, 8 g of yeast extract powder, 6 g of nucleic acid-based seasoning and 2 g of dried kelp extract) were added to and the water-thinned miso was mixed uniformly with a domestic rubber-made spatula. The water content of thus obtained seasoned bean paste was 58.8% by weight.

Next, the seasoned bean paste was loaded in three Styrofoam-made containers having dimensions of 215×150×30 (mm). The thickness of the paste layers made here was 22 mm. Each container was let stand in a freezer of −25° C. for 7 hours to non-fluidize the paste. In the non-fluid paste, holes were made in each paste with a metal rod having a diameter of 0.8 mm, which was pieced to make each hole from the upper surface of the paste to the central portion thereof at an interval of about 2 cm. After that, each container was placed directly on a shelf of a freeze-drier, and freeze-dried at a vacuum degree of 0.4 Torr and a shelf temperature of 60° C. to 40° C. Each of thus obtained freeze-dried bean pastes did not show foaming, browning or deformation, but had a dense but extremely finely porous structure inside, which required a great power to be broken by hand. In each freeze-dried miso, when hot water was poured onto it, it quickly dissolves and a miso soup having flavor and taste as good as those of the original bean paste was obtained.

As described above, according to the present invention, the water content of bean paste can be sublimated or evaporated from the bottom portion of the paste, which conventionally could not become a dry surface, while freeze-drying the paste, which made it possible to significantly improve the solubility of the bean paste to hot water poured thereto. Further, the amount of water added during the preparation of water-thinned paste can be reduced as compared to the conventional technique, and therefore it becomes possible to provide a method of manufacturing freeze-dried bean paste, with a reduced drying cost. Furthermore, according to the present invention, it is possible to manufacture a freeze-dried bean paste into a novel shape such as flake, in addition to grain and powder. In each shape, the flavor and taste have been improved as compared to those of the conventional technique, thereby increasing the commercial value of the product.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of manufacturing freeze-dried bean paste, comprising:
adding water to a bean paste and mixing the water with the bean paste to make a water-thinned bean paste;
loading the water-thinned bean paste in a container and chilling the container to non-fluidize the paste;
transferring thus the non-fluidized bean paste to another air permeable container; and
freeze-drying the non-fluidized bean paste transferred to the air permeable container so as to sublimate or evaporate water content from an entire surface of the bean paste.

2. The method according to claim 1, wherein the air permeable container is a tray-shaped container in which a wire netting or a hole-punched plate is provided with a slight gap between a bottom surface of the tray and the wire netting or hole punched plate.

3. The method according to claim 1, wherein the air permeable container has such an irregular inner surface that a gap is provided between the non-fluidized bean paste loaded in the container and the container.

4. The method according to claim 1, wherein a bottom surface of the chilled and non-fluidized bean paste is formed to have an irregularity, and the paste is loaded in a container with the irregular surface facing downwards, to create a gap between the container and the non-fluidized bean plate.

5. The method according to claim 1, wherein a plurality of holes are made or lines are carved in the chilled and non-fluidized bean paste.

6. The method according to claim 1, wherein the air permeable container is a tray-shaped container in which a wire netting or a hole punched plate is provided with a slight gap between a bottom surface of the tray and the wire netting or hole punched plate itself.

7. The method according to any one of claims 1 to 5, wherein the chilled and non-fluidized bean paste is obtained by chilling and non-fluidizing water-thinned bean paste having a water content of 56 to 70% by weight.
